(19) United States
(12) Patent Application Publication
(10) Pub. No.: US 2019/0193558 A1
(43) Pub. Date: Jun. 27, 2019

(54) SYSTEM FOR PROVIDING TORQUE ASSIST IN A VEHICLE

(71) Applicant: Caterpillar Inc., Peoria, IL (US)

(72) Inventors: Paul Anthony Dvorak, Peoria, IL (US); Corwin Eugene Storer, Bartonsville, IL (US); Richard D. Johnston, Moweaqua, IL (US)

(73) Assignee: Caterpillar Inc., Peoria, IL (US)

(21) Appl. No.: 15/851,820

(22) Filed: Dec. 22, 2017

(51) Int. Cl. B60K 17/10; B60K 17/356; F16H 47/04

(52) U.S. Cl. CPC B60K 17/10; B60K 17/356; F16H 2047/045; B60Y 2400/3032; B60Y 2200/20; F16H 47/04

(57) ABSTRACT

A system for providing torque assist in a vehicle includes a hydrostatic transmission that is associated with otherwise unpowered wheels of the vehicle. Operation of the hydrostatic transmission can be commanded by a controller based on sensor inputs, indicative of wheel speeds of each wheel present in the vehicle, to provide torque to the otherwise unpowered wheels of the vehicle. Moreover, when torque difference exists between one wheel and another from the otherwise unpowered wheels, the controller can independently and selectively actuate one or more pumps that are included in the hydrostatic transmission so that each wheel from the set of otherwise unpowered wheels rotates at the same wheel speed.

### TECHNICAL FIELD

The present disclosure relates to a wheeled vehicle, and more particularly, to a system and method for providing torque assist in a wheeled vehicle.

### BACKGROUND

Many wheeled vehicles such as off-highway trucks may be used for commercial, work, or other similar applications. In some cases, a layout of a prime mover and a transmission included in these wheeled vehicles may be characteristic of a front-wheel drive (FWD) setup in which the prime mover e.g., an engine or an electric motor and the transmission are configured to provide torque to a set of front wheels alone. In other cases, these vehicles may be characteristic of a rear-wheel drive (RWD) vehicle in which the prime mover and the transmission are configured to provide torque to a set of rear wheels alone. In a vehicle having a FWD or a RWD setup, the vehicle may rely on torque provided to either of the front wheels or the rear wheels alone to propel the vehicle.

When poor traction conditions are present or when such vehicles encounter gradients in their path of travel, it may become difficult to propel these vehicles considering that the torque is available only at the front wheels or the rear wheels alone. Some previously known strategies have been developed to overcome the aforementioned shortcoming by providing an all-wheel drive system to the vehicle. For instance, U.S. Pat. No. 6,508,328 (hereinafter referred to as “the '328 patent”) relates to a hydrostatic transmission that is used as part of an all-wheel drive (AWD) system of a motor grader. The '328 patent discloses that each front wheel of the motor grader includes its own drive system comprising a pump, a hydraulic motor, and a bypass valve that is provided to protect the hydraulic motor from cavitation conditions. The bypass valve also facilitates the hydrostatic transmission to avoid occurrences of “hydrostatic braking” and therefore, avoid wastage of otherwise usable power.

The hydrostatic transmission of the '328 patent has been disclosed in conjunction with a motor grader for rendering the motor grader as an AWD vehicle. Although the hydrostatic transmission of the '328 patent, when operational, can render a motor grade as an AWD vehicle, it will be acknowledged that a motor grader would typically encounter working conditions different from those that are likely to be experienced by other types of FWD or RWD vehicles, such as off-highway trucks. Therefore, it may be helpful to provide a system to such other types of FWD or RWD vehicles so that such other types of FWD or RWD vehicles can operatively mimic an AWD vehicle when poor traction conditions are present or when such other types of FWD or RWD vehicles encounter gradients in their path of travel.

### SUMMARY OF THE DISCLOSURE

In one aspect of the present disclosure, a system for providing torque assist in a vehicle having a first set of wheels and a second set of wheels includes a hydrostatic transmission, multiple speed sensors, and a controller. The hydrostatic transmission includes a pair of pumps in which each of the pumps is configured to output pressurized fluid therefrom. The hydrostatic transmission also includes a pair of hydraulic motors that are fluidly coupled to the pair of pumps and the first set of wheels such that each hydraulic motor is configured to be driven by pressurized fluid output from a corresponding one of the pumps.

The speed sensors are associated with the first and second sets of wheels. Each speed sensor is configured to output a wheel speed associated with a corresponding one of the first and second sets of wheels. The controller is disposed in communication with each speed sensor and each pump from the pair of pumps. The controller is configured to compute an aggression factor for the first set of wheels from a ratio between an average of the wheel speeds for the second set of wheels and an average of the wheel speeds for the first set of wheels, determine if the aggression factor is greater than a first predefined limit, and selectively actuate operation of the pair of pumps to drive the pair of hydraulic motors so that corresponding ones of the planetary gear sets are rotatively driven to provide torque to corresponding ones of the first set of wheels.

In an additional aspect of the present disclosure, these pumps are variable displacement bi-directional pumps. Also, in a further aspect of the present disclosure, the controller is configured to independently operate each pump from the pair of pumps until the aggression factor is less than the first predefined limit.

In yet an additional aspect of the present disclosure, the hydrostatic transmission further includes a pair of planetary gear sets that are disposed between and coupled to corresponding ones of the pair of hydraulic motors and the first set of wheels. Each planetary gear set includes a sun gear that is configured to remain stationary, multiple planet gears that are disposed in mesh with the sun gear, and a planet carrier that is rigidly coupled to the plurality of planet gears and an output shaft of a corresponding one of the hydraulic motors. Additionally, each planetary gear set further comprises a ring gear that is disposed in mesh with the planet gears and coupled to a corresponding one of the first set of wheels.

In yet an additional aspect of this disclosure, each of the hydraulic motors is a radial piston motor having a casing, a cam ring that is defined on an inner surface of the casing, and a block that is rotatably disposed within the casing. The block is configured to define multiple cylinders radially arranged therein. Also, this block would be coupled to the planet carrier of a corresponding planetary gear set. The radial piston motor further includes pistons that are slidably disposed in corresponding ones of the cylinders defined in the block. These pistons are biased against the cam ring and rotatively drive the block in response to a receipt of pressurized fluid serially in the cylinders of the block from a corresponding one of the pumps via a distribution valve.

In another aspect of this disclosure, the hydrostatic transmission includes at least one electronically controlled valve disposed in communication with the controller. The at least one electronically controlled valve is configured to selectively allow flow from each of the pumps to corresponding ones of the hydraulic motors.

In a further aspect of the present disclosure, the system also includes a pair of pressure sensors that are disposed in communication with the controller. Each pressure sensor would be configured to output a value that is indicative of pressure between each pump and a corresponding one of the hydraulic motors. In response to a receipt of pressure values from the pair of pressure sensors, the controller could be configured to determine a difference in pressure values between the pair of pressure sensors, determine whether a difference in torque between the first set of wheels, obtained from a correlation of the difference in pressure values, is larger than a second predefined limit, and selectively vary an amount of displacement associated with at least one of the pumps until the wheel speed associated with each wheel from the first set of wheels is equal.

Further, aspects of this disclosure are also directed to a vehicle having a first set of wheels, a second set of wheels, and employing the system disclosed herein to provide torque assist to the first set of wheels. Furthermore, aspects of this disclosure have also been directed to a method for providing torque assist in a vehicle.

Other features and aspects of this disclosure will be apparent from the following description and the accompanying drawings.

### BRIEF DESCRIPTION OF THE DRAWINGS

FIG. 1 is a bottom perspective view of an exemplary vehicle showing a frame and wheels rotatably supported on the frame;

FIG. 2 is a schematic illustration of a system for providing torque assist in the exemplary vehicle, according to an embodiment of the present disclosure;

FIG. 3 is a diagrammatic illustration of a portion of a hydrostatic transmission associated with the system of FIG. 2 and located adjacent to the wheel of the exemplary vehicle, according to embodiments of the present disclosure; and

FIG. 4 is a flowchart of a method depicting steps to provide torque assist in the exemplary vehicle, according to an embodiment of the present disclosure; and

FIG. 5 is a schematic illustration of a system for providing torque assist in the exemplary vehicle, according to an alternative embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

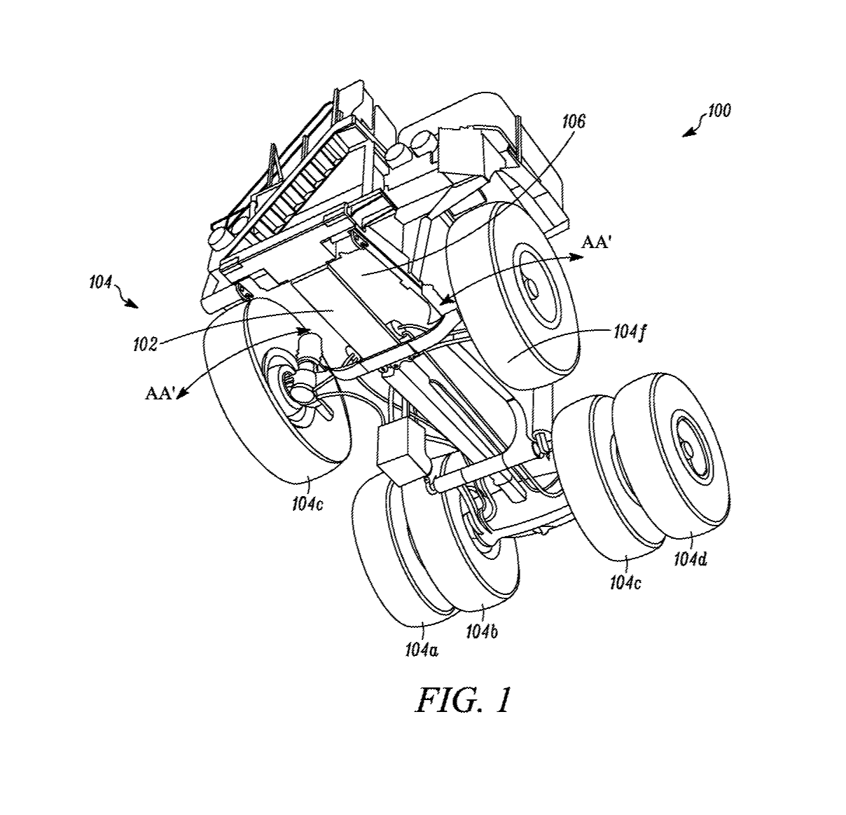

FIG. 1 illustrates an exemplary vehicle 100. The vehicle 100 may be a mobile machine that performs some type of operation associated with an industry such as mining, construction, farming, transportation or any other industry known in the art. In an example as shown in FIG. 1, the vehicle 100 is embodied in the form of an off-highway truck.

Although the vehicle 100 shown in FIG. 1 is embodied in the form of an off-highway truck, in other embodiments, the vehicle 100 may include a dozer, a loader, a backhoe, an excavator, a motor grader, or any other earth moving machine known to persons skilled in the art. Moreover, the vehicle 100 may also include other operation-performing work machines such as a truck having a generator set mounted thereon, or a truck having one or more rig pumps mounted thereon. In fact, the vehicle 100 may optionally include other types of machines including passenger cars, but is not limited thereto. It will be acknowledged that a type of vehicle used for implementing embodiments disclosed herein is non-limiting of this disclosure. Rather, it will be appreciated by persons skilled in the art that aspects of the present disclosure may be applied to any type of vehicle having a frame and wheels as will be evident from the following disclosure.

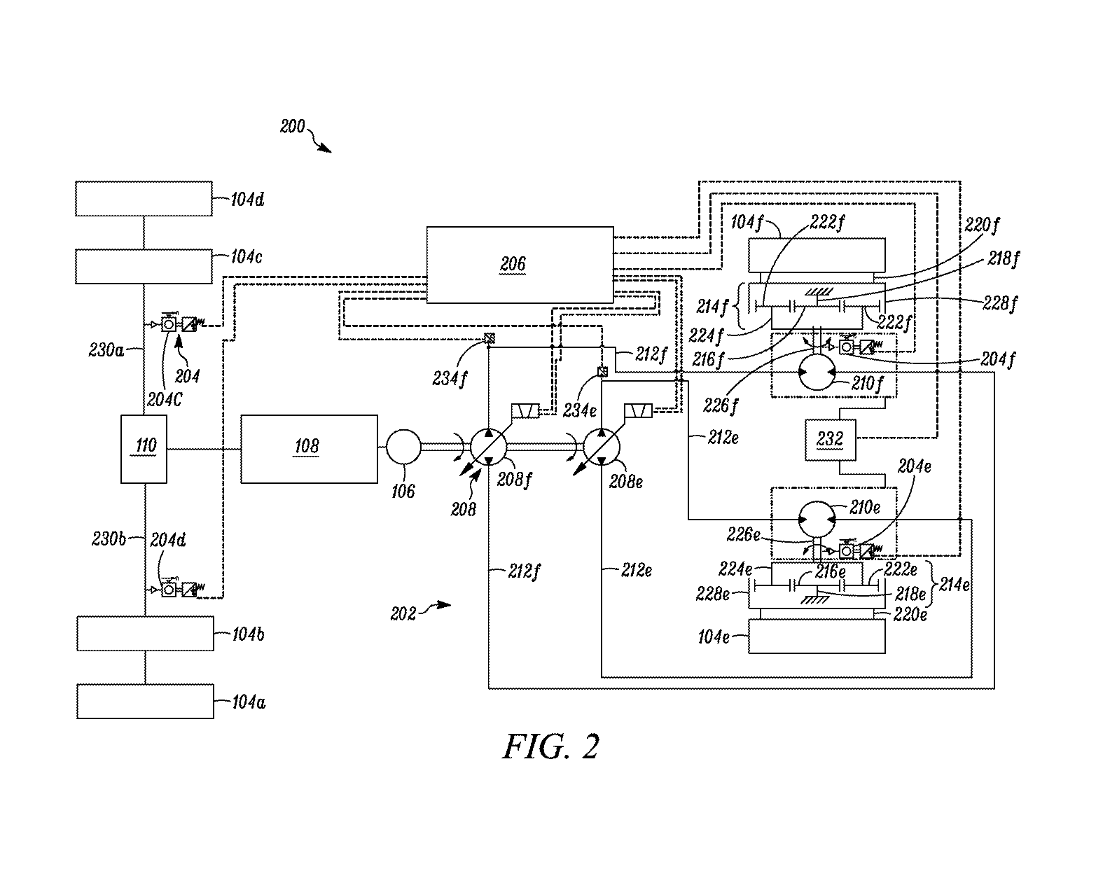

As shown in FIG. 1, the vehicle 100 may include a frame 102, and a plurality of wheels 104 rotatably supported on the frame 102. The wheels 104 may include a set of powered wheels 104a-104d disposed at an aft portion of the vehicle 100. These powered wheels 104a-104d may be “mechanically driven” by a prime mover 106. The prime mover 106 may include, but is not limited to, an engine, an electric motor, or any other type of prime mover known to persons skilled in the art for propelling the vehicle 100 on a ground surface. Referring to a schematic illustration of the vehicle 100 in FIG. 2, the vehicle 100 may include a transmission system and a differential system that mechanically transmit drive power from the prime mover 106 to the set of powered wheels 104a-104d.

Referring to FIGS. 1-2, the wheels 104 also include a pair of steering wheels 104e, 104f disposed at a fore of the vehicle 100. It may be noted that a number of steering wheels disclosed herein is merely exemplary in nature and hence, non-limiting of this disclosure. Rather, a number of steering wheels used in a vehicle may depend on a type of vehicle used and hence, may vary from one type of a vehicle to another. In operation, the set of steering wheels 104e, 104f allows an operator of the vehicle 100 to steer the vehicle 100 on a desired path of travel. As shown in FIG. 1, each of the steering wheels 104e, 104f is capable of operatively executing a swiveling movement shown by way of directional arrows AA′.

The present disclosure relates to a system 200 for providing torque assist in the vehicle 100. For sake of the present disclosure, the pair of steering wheels 104e and 104f will hereinafter be referred to as “the first set of wheels” and denoted by identical alpha-numerals “104e” and “104f”. Moreover, when references are made to the first set of wheels 104e. 104f in the singular, the first set of wheels 104e, 104f may be regarded as having a front right (FR) wheel and a front left (FL) wheel each of which are denoted with identical alpha-numerals “104e” and “104f” respectively.

Similarly, the set of powered wheels 104a-104d will hereinafter be referred to as “the second set of wheels” and denoted by identical alpha-numerals “104a-104d”. Moreover, the second set of wheels 104a-104d may be regarded as being inclusive of a right set of second wheels 104a-104b, and a left set of second wheels 104c-104d.

As shown in FIG. 2, the system 200 includes a hydrostatic transmission 202, multiple speed sensors 204, and a controller 206. The hydrostatic transmission 202 includes a pair of pumps 208 in which each of the pumps 208 is configured to output pressurized fluid therefrom. As shown in the illustrated embodiment of FIG. 2, each of the pumps 208 is embodied, for instance, in the form of a variable displacement bi-directional pump whose displacement can be varied based on, amongst other things, a steering movement of the first set of wheels 104e, 104f or an amount of payload associated with the vehicle 100 that manifests itself as a resistance to the movement of the first set of wheels 104e, 104f as the vehicle 100 is in operation. It may be noted that the pumps 208, employed for use in powering the first set of wheels 104e, 104f may also be used to power other hydraulic systems that could be present on the vehicle 100.

The hydrostatic transmission 202 also includes a pair of hydraulic motors 210 that are associated with the first set of wheels 104e-104f and each hydraulic motor 210e-210f is configured to be driven by pressurized fluid output from a corresponding one of the pumps 208e-208f. As shown, these hydraulic motors 210e-210f are fluidly coupled to the pair of pumps 208e-208f in a closed loop fashion using a first fluid line 212e and a second fluid line 212f respectively.

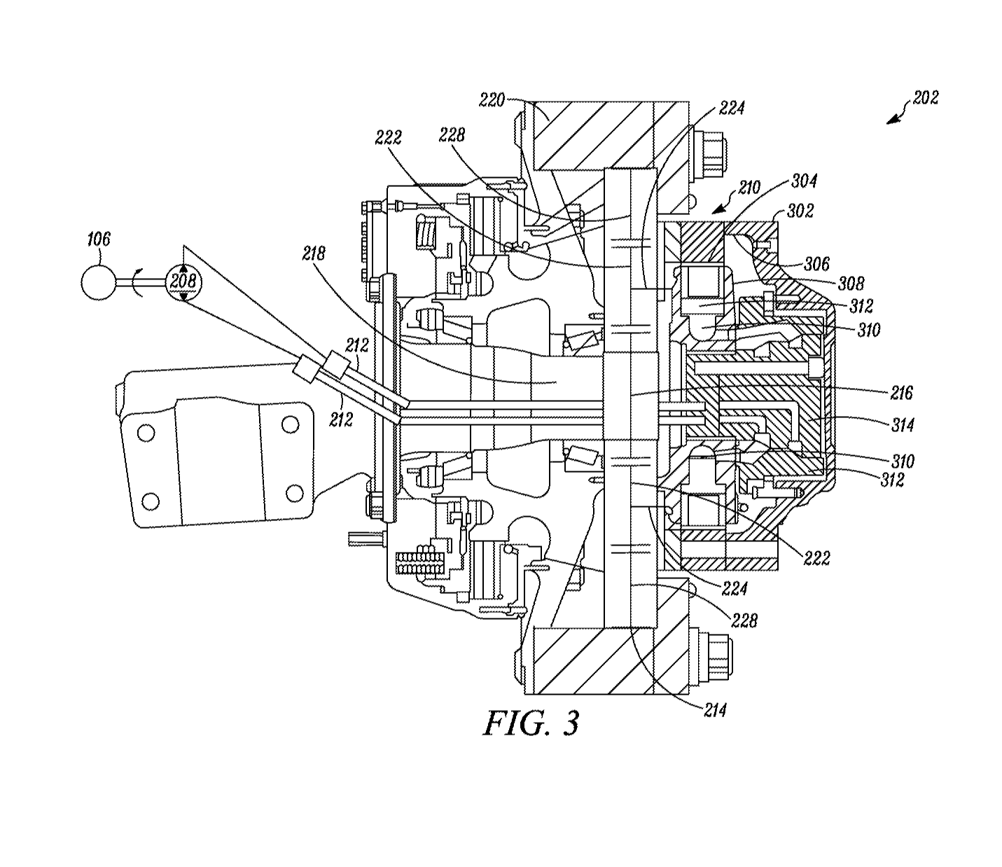

As shown in the illustrated embodiment of FIG. 3, each of the hydraulic motors 210 is a radial piston motor having a casing 302, a cam ring 304 that is defined on an inner surface 306 of the casing 302, and a block 308 that is rotatably disposed within the casing 302. The block 308 is configured to define multiple cylinders 310 radially arranged therein. Also, this block 308 would be coupled to a planet carrier 224 of a corresponding planetary gear set 214. The radial piston motor 210 further includes pistons 312 that are slidably disposed in corresponding ones of the cylinders 310 defined in the block 308. These pistons 312 are biased against the cam ring 304 and rotatively drive the block 308 in response to a receipt of pressurized fluid serially in the cylinders 310 of the block 308 from a corresponding one of the pumps 208 via a distribution valve 314.

As shown in FIG. 2, the hydrostatic transmission 202 further includes a pair of planetary gear sets 214e-214f coupled to the pair of hydraulic motors 210e-210f and the first set of wheels 104e-104f. In the illustrated embodiment of FIGS. 2-3, each of these planetary gear sets 214 is embodied as an epicyclic planetary gear set. However, in other embodiments, other configurations of planetary gear sets including, but not limited to, a Simpson planetary gear set, or a Ravigneaux planetary gear set may be used in lieu of the epicyclic planetary gear set disclosed herein depending on specific requirements of an application.

With reference to the illustrated embodiment of FIGS. 2-3, each planetary gear set 214 includes a sun gear 216 that is configured to remain stationary. The sun gear 216 may be rigidly disposed on a fixed spindle 218 about which a hub 220 of an associated wheel 104e or 104f rotates. Further each planetary gear set 214 also includes multiple planet gears 222 that are disposed in mesh with the sun gear 216, and a planet carrier 224 that is rigidly coupled to the plurality of planet gears 222. The planet carrier 224 is also coupled to an output shaft 226 of a corresponding one of the hydraulic motors 210. As best shown in FIG. 2, the planet carrier 224e from the planetary gear set 214e associated with the FR wheel 104e is rigidly coupled to the output shaft 226e associated with the hydraulic motor 210e while the planet carrier 224f from the planetary gear set 214f associated with the FL wheel 104f is rigidly coupled to the output shaft 226f associated with the hydraulic motor 210f.

Additionally, as shown in FIG. 2, each of the planetary gear sets 214 further comprises a ring gear 228 that is disposed in mesh with the planet gears 222 and coupled to a corresponding one of the first set of wheels 104e or 104f. Referring to the illustrated embodiment of FIG. 3, the ring gear 228 from each planetary gear set 214 could be rigidly coupled to the hub 220 of a corresponding one of the first set of wheels i.e., the FR wheel 104e or the FL wheel 104f.

Moreover, as shown in FIG. 2, the speed sensors 204 are associated with the first and second sets of wheels 104a-104f. For instance, the speed sensor 104c is associated with a left rear axle 230a disposed between the differential system 110 and the left set of second wheels 104c-104d. Similarly, the speed sensor 104d is associated with a right rear axle 230b disposed between the differential system 110 and the right set of second wheels 104a-104b. Each speed sensor 204 is configured to output a wheel speed associated with a corresponding one of the first and second sets of wheels 104. The system 200 also includes a controller 206 that is disposed in communication with each speed sensor 204 and each pump 208 from the pair of pumps 208e-208f.

During operation of the vehicle 100, the controller 206 is configured to compute an aggression factor for the first set of wheels 104e-104f from a ratio between an average of the wheel speeds for the second set of wheels 104a-104d and an average of the wheel speeds for the first set of wheels 104e-104f. The controller 206 then determines if the aggression factor is greater than a first predefined limit, and selectively actuates operation of the pair of pumps 208e-208f to drive the pair of hydraulic motors 210e-210f so that corresponding ones of the planetary gear sets 214e-214f are rotatively driven to provide torque to corresponding ones of the first set of wheels 104e-104f. Also, the controller 206 disclosed herein would be configured to independently and selectively operate each pump 208e-208f from the pair of pumps 208 until the aggression factor is less than the first predefined limit.

In yet another aspect of this disclosure as shown in FIG. 2, the hydrostatic transmission 202 includes at least one electronically controlled valve 232 that would be disposed in communication with the controller. The electronically controlled valve 232 is configured to selectively allow flow from each of the pumps 208e-208f to corresponding ones of the hydraulic motors 210e-210f. With regards to a configuration of the electronically controlled valve 232, it is hereby contemplated that the electronically controlled valve 232 may be embodied in the form of an electromagnetically operated relief valve or any other suitable type of valve configuration known to persons skilled in the art. Therefore, it must be noted that a type of valve configuration used to form the electronically controlled valve 232 disclosed herein is non-limiting of this disclosure. Rather, any type of valve configuration known to persons skilled in the art may be used to form the electronically controlled valve 232 disclosed herein such that the electronically controlled valve 232 is configured to perform functions that are consistent with the present disclosure.

In a further aspect of the present disclosure as shown in FIG. 2, the system 200 also includes a pair of pressure sensors 234e-234f that are disposed in communication with the controller 206. Each pressure sensor 234e-234f would be configured to output a value that is indicative of pressure between each pump 208e-208f and a corresponding one of the hydraulic motors 20e-210f. In response to a receipt of pressure values from the pair of pressure sensors 234e-234f, the controller 206 could be configured to determine a difference in pressure values between the pair of pressure sensors 234e-234f. The controller 206 may then co-relate the difference in pressure values to obtain a difference in torque between the first set of wheels 104e and 104f. Thereafter, the controller 206 may determine if the torque difference between the first set of wheels 104e and 104f is larger than a second predefined limit. If so, the controller 206 would be configured to vary an amount of displacement associated with at least one of the pumps 208e and/or 208f until the wheel speed associated with each wheel 104 from the first set of wheels 104e and 104f is equal.

It may be noted that in embodiments of the present disclosure, the controller 206 is configured with suitable algorithms, programs, circuitry such as, but not limited to, power supply circuitry, signal conditioning circuitry, solenoid driver circuitry, alarm driving circuitry, and the like for executing functionality consistent with the present disclosure. Moreover, algorithms and programs associated with the controller 206 can reside on one or more devices known to persons skilled in the art. Some examples of such devices may include, but is not limited to, read only memory (ROM), random access memory (RAM), floppy disks, compact disks, portable hard disks, and the like. Such devices may be contemplated and suitably implemented by one skilled in the art, in conjunction with the controller 206 to execute functions that are consistent with the present disclosure.

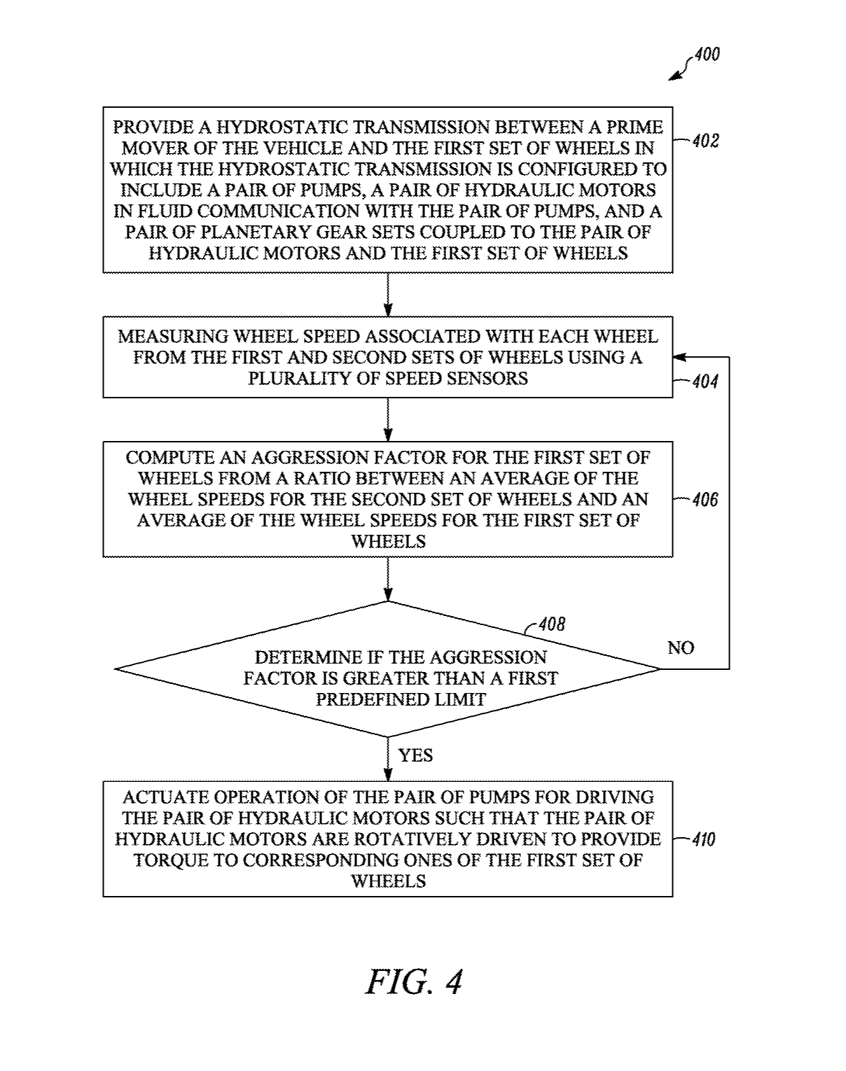

FIG. 4 illustrates a flowchart depicting a method 400 for providing torque assist in the vehicle 100 having a first set of wheels 104e-104f and a second set of wheels 104a-104d. As shown in FIG. 4, at step 402, the method 400 includes providing a hydrostatic transmission 202 between a prime mover 106 of the vehicle 100 and the first set of wheels 104e-104f in which the hydrostatic transmission 202 comprises a pair of pumps 208e-208f, a pair of hydraulic motors 210e-210f in fluid communication with the pair of pumps 208e-208f, and a pair of planetary gear sets 214e-214f coupled to the pair of hydraulic motors 210e-210f and the first set of wheels 104e-104f. At step 404, the method 400 includes measuring wheel speed associated with each wheel 104 from the first and second sets of wheels 104a-104f using the plurality of speed sensors 204c-204f. At step 406, the method 400 then includes computing an aggression factor for the first set of wheels 104e-104f from a ratio between an average of the wheel speeds for the second set of wheels 104a-104d and an average of the wheel speeds for the first set of wheels 104e-104f.

The method 400 then proceeds from step 406 to step 408 in which the method 400 includes determining if the aggression factor is greater than a first predefined limit. If so, then the method 400 proceeds from step 408 to step 410 in which the method 400 includes actuating operation of the pair of pumps 208e-208f, by means of the controller 206, for driving the pair of hydraulic motors 210e-210f so that corresponding ones of the planetary gear sets 214c-214f are rotatively driven to provide torque to corresponding ones of the first set of wheels 104e-104f.

However, if at step 408, the controller 206 determines that the aggression factor is less than the first predefined limit, then the method 400 may be configured to loop from step 408 to step 404 in which the wheel speeds of the first and second sets of wheels 104a-104f are measured for subsequently performing steps 406-408 disclosed herein for realizing functions that are consistent with the present disclosure.

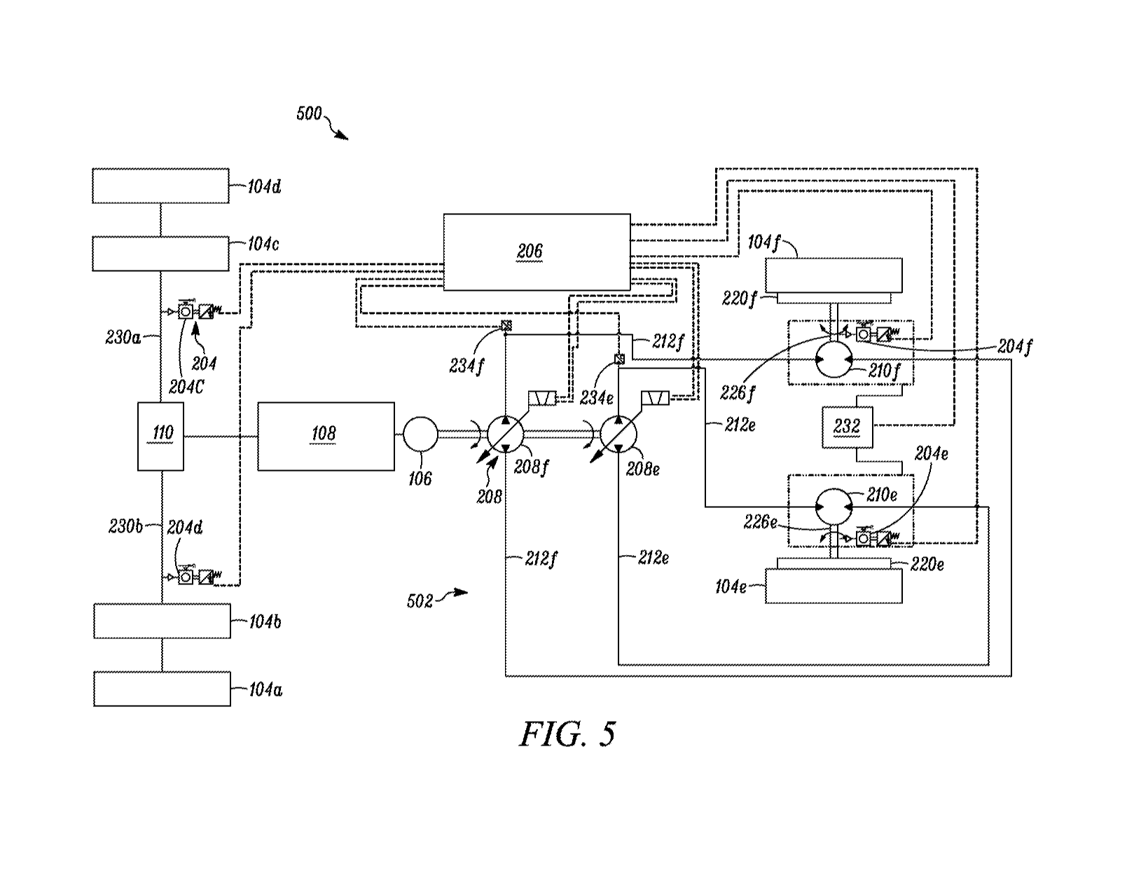

Although in the illustrated embodiment of FIG. 2, the planetary gear sets 214e, 214f have been disclosed as forming part of the system 200, it may be noted an inclusion of the planetary gear sets 214e, 214f is not always necessary and therefore, a configuration of the system 200 could be construed as being non-limiting of this disclosure. In an alternative embodiment of the present disclosure, a system 500 having a hydrostatic transmission 502 for providing torque assist to the first set of wheels 104e, 104f is shown in the diagrammatic illustration of FIG. 5. In this embodiment, the pair of planetary gear sets 214e, 214f shown in FIG. 2 may be omitted such that the output shafts 226e, 226f of the pair of hydraulic motors 210e, 201f are connected directly to the pair of hubs 220e, 220f from corresponding ones of the first set of wheels 104e, 104f. Consequently, in this embodiment, torque may be transmitted directly from the output shafts 226e, 226f of the pair of hydraulic motors 210e, 201f into driving corresponding ones of the first set of wheels 104e, 104f via the pair of wheel hubs 220e, 220f respectively.

### INDUSTRIAL APPLICABILITY

Embodiments of the present disclosure have applicability for use in providing torque assist in a wheeled vehicle. The system 200 of the present disclosure, when implemented in a vehicle having a conventionally known RWD or FWD setup can help such wheeled vehicles to mimic an all-wheel drive (AWD) setup and help improve use of an overall tractive effort for the wheeled vehicle when poor traction conditions exist in the path of travel for such wheeled vehicles or when such wheeled vehicles are required to travel uphill in which such wheeled vehicles would otherwise typically rely on torque that was previously provided to either of the front wheels or the rear wheels alone.

Implementation of the system 200 disclosed herein may also serve as a cost-effective alternative to installation of an otherwise expensive mechanical transmission setup such as a transmission and a differential system. Also, with use of a “hystat” radial base piston motor for each of the hydraulic motors 210 disclosed herein, it is envisioned that the hydraulic motors 210 are imparted with adequate robustness. As known to persons skilled in the art, these “hydrostat” radial base piston motors are generally capable of withstanding high loads and subsequently high fluid pressure to counteract the high amounts of load, typically experienced by wheeled vehicles including, but not limited to, off-highway trucks, dump trucks, and the like. Therefore, the hydraulic motors 210 disclosed herein may exhibit improved reliability in operation and require little to no maintenance even when subject to severe loading conditions or with use for a prolonged period of time.

While aspects of the present disclosure have been particularly shown and described with reference to the embodiments above, it will be understood by those skilled in the art that various additional embodiments may be contemplated by the modification of the disclosed vehicles, systems and methods without departing from the spirit and scope of what is disclosed. Such embodiments should be understood to fall within the scope of the present disclosure as determined based upon the claims and any equivalents thereof.

What is claimed is:

1. A system for providing torque assist in a vehicle having a first set of wheels and a second set of wheels, the system comprising:
a hydrostatic transmission comprising:
a pair of pumps, each of the pumps configured to output pressurized fluid therefrom;
a pair of hydraulic motors fluidly coupled to the pair of pumps and the first set of wheels such that each hydraulic motor is configured to be driven by pressurized fluid output from a corresponding one of the pumps; and
a plurality of speed sensors associated with the first and second sets of wheels, each of the speed sensors configured to output a wheel speed associated with a corresponding one of the first and second sets of wheels; and
a controller disposed in communication with each of the speed sensors and each of the pumps, the controller configured to:
compute an aggression factor for the first set of wheels from a ratio between an average of the wheel speeds for the second set of wheels and an average of the wheel speeds for the first set of wheels;
determine if the aggression factor is greater than a first predefined limit; and
selectively actuate operation of the pair of pumps to drive the pair of hydraulic motors such that the pair of hydraulic motors provide torque to corresponding ones of the first set of wheels.

2. The system of claim 1, wherein the pumps are variable displacement pumps.

3. The system of claim 1, wherein the hydrostatic transmission further comprises a pair of a pair of planetary gear sets that are disposed between and coupled to the pair of hydraulic motors and corresponding ones of the first set of wheels.

4. The system of claim 3, wherein each planetary gear set comprises:
a sun gear that is configured to remain stationary;
a plurality of planet gears disposed in mesh with the sun gear;
a planet carrier rigidly coupled to the plurality of planet gears and an output shaft of a corresponding one of the hydraulic motors;
a ring gear disposed in mesh with the plurality of planet gears and coupled to a corresponding one of the first set of wheels.

5. The system of claim 4, wherein each of the hydraulic motors is a radial piston motor having:
a casing;
a cam ring defined on an inner surface of the casing;
a block rotatably disposed within the casing and defining a plurality of cylinders radially arranged therein, the block being coupled to the planet carrier of a corresponding planetary gear set; and
a plurality of pistons slidably disposed in the plurality of cylinders, wherein the pistons are biased against the cam ring and configured to rotatively drive the block in response to a receipt of pressurized fluid serially in the cylinders of the block from a corresponding one of the pumps via a distribution valve.

6. The system of claim 1, wherein the hydrostatic transmission includes at least one electronically controlled valve disposed in communication with the controller, the at least one electronically controlled valve configured to selectively allow flow from each of the pumps to corresponding ones of the hydraulic motors.

7. The system of claim 1, wherein the controller is configured to independently operate each pump from the pair of pumps until the aggression factor is less than the first predefined limit.

8. The system of claim 1 further comprising a pair of pressure sensors disposed in communication with the controller, wherein each pressure sensor is configured to output a value indicative of pressure between each pump and a corresponding one of the hydraulic motors.

9. The system of claim 8, wherein in response to a receipt of pressure values from the pair of pressure sensors, the controller is configured to:
determine a difference in pressure values between the pair of pressure sensors;
determine whether a difference in torque between the first set of wheels, correlated from the difference in pressure values, is larger than a second predefined limit; and
selectively vary an amount of displacement associated with at least one of the pumps until the wheel speed associated with each wheel from the first set of wheels is equal.

10. A vehicle comprising:
a frame;
a prime mover;
a first set of wheels rotatably supported on the frame;
a second set of wheels rotatably supported on the frame and configured to be driven by the prime mover by means of a drivetrain assembly;
a hydrostatic transmission associated with the prime mover and coupled to the first set of wheels, the hydrostatic transmission comprising:
a pair of pumps configured to be driven by the prime mover such that each of the pumps is configured to output pressurized fluid therefrom;
a pair of hydraulic motors fluidly coupled to the pair of pumps and the first set of wheels such that each hydraulic motor is configured to be driven by pressurized fluid output from a corresponding one of the pumps; and
a plurality of speed sensors associated with the first and second sets of wheels, each of the speed sensors configured to output a wheel speed associated with a corresponding one of the first and second sets of wheels; and
a controller disposed in communication with each of the speed sensors and each of the pumps, the controller configured to:
compute an aggression factor for the first set of wheels from a ratio between an average of the wheel speeds for the second set of wheels and an average of the wheel speeds for the first set of wheels;
determine if the aggression factor is greater than a first predefined limit; and
selectively actuate operation of the pair of pumps to drive the pair of hydraulic motors such that such that the pair of hydraulic motors provide torque to corresponding ones of the first set of wheels.

11. The vehicle of claim 10, wherein the pumps are variable displacement pumps.

12. The vehicle of claim 10, wherein the hydrostatic transmission further comprises a pair of a pair of planetary gear sets that are disposed between and coupled to the pair of hydraulic motors and corresponding ones of the first set of wheels.

13. The vehicle of claim 12, wherein each planetary gear set comprises:
a sun gear that is configured to remain stationary by means of a rigid coupling with a spindle associated with a corresponding one of the first set of wheels;
a plurality of planet gears disposed in mesh with the sun gear;
a planet carrier rigidly coupled to the plurality of planet gears and an output shaft of a corresponding one of the hydraulic motors;
a ring gear disposed in mesh with the plurality of planet gears and coupled to a corresponding one of the first set of wheels.

14. The vehicle of claim 13, wherein each of the hydraulic motors is a radial piston motor having:
a casing;
a cam ring defined on an inner surface of the casing;
a block rotatably disposed within the casing and defining a plurality of cylinders radially arranged therein, the block being coupled to the planet carrier of a corresponding planetary gear set; and
a plurality of pistons slidably disposed in the plurality of cylinders, wherein the pistons are biased against the cam ring and configured to rotatively drive the block in response to a receipt of pressurized fluid serially in the cylinders of the block from a corresponding one of the pumps via a distribution valve.

15. The vehicle of claim 10, wherein the hydrostatic transmission includes at least one electronically controlled valve disposed in communication with the controller, the at least one electronically controlled valve configured to selectively allow flow from each of the pumps to corresponding ones of the hydraulic motors.

16. The vehicle of claim 10, wherein the controller is configured to independently operate each pump from the pair of pumps until the aggression factor is less than the first predefined limit.

17. The vehicle of claim 10 further comprising a pair of pressure sensors disposed in communication with the controller, wherein each pressure sensor is configured to output a value indicative of pressure between each pump and a corresponding one of the hydraulic motors.

18. The vehicle of claim 17, wherein in response to a receipt of pressure values from the pair of pressure sensors, the controller is configured to:
determine a difference in pressure values between the pair of pressure sensors;
determine whether a difference in torque between the first set of wheels, correlated from the difference in pressure values, is larger than a second predefined limit; and
selectively vary an amount of displacement associated with at least one of the pumps until the wheel speed associated with each wheel from the first set of wheels is equal.

19. A method for providing torque assist in a vehicle having a first set of wheels and a second set of wheels, the method comprising:
providing a hydrostatic transmission between a prime mover of the vehicle and the first set of wheels, wherein the hydrostatic transmission comprises a pair of pumps, a pair of hydraulic motors in fluid communication with the pair of pumps;
measuring wheel speed associated with each wheel from the first and second sets of wheels using a plurality of speed sensors,
computing, by means of a controller communicably coupled to the plurality of speed sensors, an aggression factor for the first set of wheels from a ratio between an average of the wheel speeds for the second set of wheels and an average of the wheel speeds for the first set of wheels,
determining, by means of the controller, if the aggression factor is greater than a first predefined limit, and
selectively actuating operation of the pair of pumps, by means of the controller, for driving the pair of hydraulic motors such that the pair of hydraulic motors are rotatively driven to provide torque to corresponding ones of the first set of wheels.

20. The method of claim 19 further comprising operating, by means of the controller, each pump from the pair of pumps independently until the aggression factor is less than the first predefined limit.
